(19) United States
(12) Patent Application Publication
(10) Pub. No.: US 2024/0110067 A1
(43) Pub. Date: Apr. 4, 2024

(54) INORGANIC COATING COMPOSITION

(71) Applicant: 3M INNOVATIVE PROPERTIES COMPANY, St. Paul, MN (US)

(72) Inventors: Walter R. Romanko, Austin, TX (US); Mitchell T. Huang, Austin, TX (US); Rhesa M. Browning, Austin, TX (US); Mark A. Fairbanks, Lino Lakes, MN (US); Daniel S. Bates, Chisago City, MN (US)

(21) Appl. No.: 18/264,800

(22) PCT Filed: Mar. 16, 2022
(86) PCT No.: PCT/IB2022/052405

§ 371 Date: Aug. 9, 2023

Related U.S. Application Data
(60) Provisional application No. 63/200,638, filed on Mar. 19, 2021.

(51) Int. Cl. C09D 1/04; C09D 1/00; C09D 5/18; C09D 7/40; C09D 7/61; C09D 7/65

(52) U.S. Cl. CPC C09D 1/04; C09D 1/00; C09D 5/18; C09D 7/61; C09D 7/65; C09D 7/70; H01M 50/28; H01M 2200/00

(57) ABSTRACT

The present invention describes a coating composition that when applied to a substrate is capable of withstanding high temperature particle ejection without perforation caused by a high energy thermal runaway event. The coating composition comprises an inorganic filler, an inorganic binder; and chopped organic fibers.

### BACKGROUND OF THE INVENTION

### Field of the Invention

The present invention relates to a coating composition for use in electric vehicle battery modules to aid in managing battery module thermal runaway incidents.

### Background

Today, the market and supporting technologies for battery supported hybrid or fully electrical driven vehicles are rapidly expanding. Rechargeable batteries, including nickel metal hydride or lithium-ion batteries are used to store energy and provide power in electric and hybrid electric vehicles. The flow of current either into the battery during recharging or out of the battery into the vehicle and its accessories generates heat. Operation outside the bounds of the specified range can damage or accelerate degradation of cells within the battery.

Electrical vehicle batteries are made up of several battery modules, and each battery module comprises many interconnected individual battery cells. When one cell in a battery module is damaged or faulty in its operation, temperatures in the cell may increase faster than heat can be removed from the module. If this temperature buildup continues unchecked, a catastrophic phenomenon called thermal runaway can occur resulting in the cell catching on fire. The resulting fire can spread very quickly to neighboring cells and then to cells throughout the entire battery in a chain reaction. These fires can be potentially massive and can spread to surrounding structures and endanger occupants of the vehicle or structures in which these batteries are located.

The next generation of electrical vehicle EV batteries will be higher energy than batteries used today. High energy batteries such as those described as 811 (NMC, or nickel—manganese—cobalt ratio) or similar energy density can fail catastrophically if punctured or overheated. When this occurs, the ensuing battery fire will not only reach temperatures of 1200° C. or above but may also expel shrapnel at moderately high velocities. While battery packs are generally encased in an aluminum shell, aluminum melts at 660° C., so the shell must be protected from the flame and shrapnel of a failed battery to allow occupants of the electrical vehicle time to exit in the event of such a failure.

While materials exist that can survive a high temperature flame (i.e. 2000° C. flame for tens of minutes with no breach), these materials cannot withstand the blast associated with a high energy battery thermal runaway event. Thus, there is a need for a fire barrier that can withstand not only high temperatures, but also the blast particles emanated from the battery pack. To survive in an automotive or other environment exposed to the elements, these materials must also be able to withstand low and high temperatures and humidities without degradation of their properties. Additionally, the exemplary material needs to be thin, lightweight, strong, and inexpensive.

### SUMMARY

The present invention describes a coating that when applied to a substrate is capable of withstanding high temperature (e.g. greater than 750° C., preferably greater than 1000° C., or more preferably greater than 1200° C.) particle ejection without perforation caused by a high energy thermal runaway event. In a first exemplary embodiment, a coating composition is described that comprises an inorganic filler, an inorganic binder; and chopped organic fibers.

In a second embodiment, a fire resistant article is described that comprises an exemplary coating composition coated onto a substrate, wherein the coating composition comprises an inorganic filler, an inorganic binder, and chopped organic fibers.

In another embodiment, an exemplary coating composition in accordance with the present invention may consist essentially of an inorganic filler, an inorganic binder; and chopped organic fibers. Said coating composition may further include additional materials which do not significantly affect the desired characteristics of the cured coating composition or the performance of fire resistant article comprising the exemplary coating disposed on product a surface of a substrate.

The above summary of the present invention is not intended to describe each illustrated embodiment or every implementation of the present invention. The figures and the detailed description that follows more particularly exemplify these embodiments.

### DETAILED DESCRIPTION OF THE EMBODIMENTS

Because components of embodiments of the present invention can be positioned in a number of different orientations, the directional terminology is used for purposes of illustration and is in no way limiting. It is to be understood that other embodiments may be utilized, and structural or logical changes may be made without departing from the scope of the present invention. The following detailed description, therefore, is not to be taken in a limiting sense, and the scope of the present invention is defined by the appended claims.

Protecting against the dangers associated with a sudden fire and/or shrapnel ejection during a thermal runaway event is a significant technical challenge. Attempting to create a universal solution is difficult to achieve because protecting against one characteristic of a battery fire may cause other problems. For example, non-woven polymeric webs and foams can display excellent thermal insulation properties, but common polymers cannot withstand the high temperatures experienced in a battery failure event. Heat shield materials made from woven non-combustible fibers (e.g., inorganic fibers) can be effective in preventing penetration of a fire but can be too thin to adequately insulate against the intense heat of a fire or shrapnel. Using thicker layers of heat shield materials may too costly. Combinations of these materials may provide a solution, but bonding dissimilar materials together can be an issue, especially when the selection of bonded and bonding materials may be constrained by flammability issues and differences of coefficient of thermal expansion.

The present invention addresses these issues by providing a fire protection coating that forms a protective ceramic surface under thermal runaway conditions. The exemplary coating can be applied to a surface of a flame resistant flame-resistant paper or a flame resistant flame-resistant board to create a fire barrier article capable of withstanding the high temperatures and expulsion of shrapnel during a thermal runaway in a high energy battery module or pack. In electric vehicle battery applications, the combination of a relatively thin flame resistant paper or board with a fire protection coating can provide protection, structural integrity and a high degree of thermal insulation in the event of fire exposure.

In one exemplary embodiment, the fire barrier article can be used to line the underside of the battery pack lid to serve as a shield from high temperature particle blasts or ejection during a catastrophic battery failure. The material form may be provided to the customer as an individual sheet (for planar applications) or may be coated on and cured to the underside of the battery pack lid (for battery pack lids having three-dimensional contours) or other three-dimensional substrate, such as the three dimensional fire resistant material described in PCT Publication No. WO 2021/113278, which is incorporated herein by reference and which can then be applied to a lid, sides or bottom of a battery pack. The requirements for this exemplary fire barrier article are well beyond simply being just flame retardant. The fire barrier article should have the ability to handle not only extremely high temperatures but must also withstand particle blasts. As a result, conventional constructions comprising organic or silicone materials would not provide the necessary protection during a high energy thermal runaway event.

Additionally, because an automobile is exposed to an array of shock and vibration, temperature and humidity extremes, chemical exposure, and other adverse conditions, the properties of automotive components must be carefully tailored. Shock and vibration in particular can be extremely challenging for many components, as these components are subjected to a range of frequencies, accelerations, and jerking motions, particularly when they are solidly affixed to the vehicle without any mechanical damping. Thus, a material's mechanical properties are an important consideration when formulating new materials for under-lid applications.

For the substantially inorganic coating systems described herein, measurement of the material's flexural properties rather than its tensile properties are used to characterize the materials. In general, it is desired to have a higher flexural modulus and a higher flexural stress at break to enable the component to survive the shock and vibration of an automotive environment, particularly for under-lid applications. Hence, it is desired to increase the flexural modulus and/or the flexural stress at break of these systems. Inorganic coating compositions according to the present invention comprise at least 90 wt. %, preferably at least 93 wt. %, more preferably 97 wt. % inorganic material based on the on the percent solids in the dried coating.

The exemplary coating composition, described herein, comprises a small concentration of organic fibers to improve the physical properties of the cured composition while also providing a cured coating layer capable of surviving high temperature particle blasts. The exemplary coating composition can be used for the underside of a battery pack lid, or in other applications where high temperature, high strength, and blast resistance is required.

The exemplary coating composition comprises an inorganic filler, an inorganic binder, and chopped organic fibers. More specifically, the coating composition may include 35-85% by weight of an inorganic filler, 15-60% by weight an inorganic binder and 0.1-6.5% by weight of chopped organic fibers based on the percent solids in the dried coating.

Exemplary inorganic fillers include, but are not limited to kaolin clay, metakaolin clay, talc, mica, mullite, phlogopite, muscovite montmorillonite, smectite, bentonite, illite, chlorite, sepiolite, attapulgite, halloysite, vermiculite, laponite, rectorite, perlite, glass fibers, ceramic fibers, fly ash, fumed silica, Portland cement, concrete mixes or similar inorganic materials, and combinations thereof. Suitable types of kaolin clay include, but are not limited to, water-washed kaolin clay, metakaolin clay, delaminated kaolin clay, calcined kaolin clay, and surface-treated kaolin clay.

In some embodiments, the inorganic filler can be a mixture of a plurality of the fillers provided above. For example, the inorganic filler can be a mixture of inorganic fillers comprising at least two fillers selected from kaolin clay, metakaolin, talc, mica, mullite, phlogopite, muscovite, montmorillonite, smectite, bentonite, illite, chlorite, sepiolite, attapulgite, halloysite, vermiculite, laponite, rectorite, perlite, fly ash, fumed silica, silica fume, Portland cement, and concrete mixes. In some exemplary embodiments, the inorganic filler is a mixture of kaolin clay and mica.

The inorganic filler can comprise 20 to 70% by weight of the wet coating composition mixture. Alternatively, the exemplary coating composition can comprise 35-85%, preferably 50-80%, more preferably 55-75% by weight of an inorganic filler based on the total solids content in the dried coating.

In some embodiments, the inorganic binders can have the formula M₂SiO₃, wherein M is Na, K or Li, and thus include sodium silicate (Na₂SiO₃), potassium silicate (K₂SiO₃) lithium silicate (Li₂SiO₃). Additionally, the inorganic binders may further include colloidal silica. In some embodiments, the inorganic binder may include combinations of at least two of the inorganic binders provided above (i.e. sodium silicate, potassium silicate, lithium silicate and colloidal silica). Alternatively, the inorganic binder can be a polysilicate having the formula M₂O(SiO₂)ₙ·H₂O, wherein M is selected from Li, Na, K, preferably K or Na and n is an integer between 1 and 15, preferably between 2 and 9. It is further preferred that the binder is employed in a solvent, preferably water. The inorganic binder can comprise 30 to 80% by weight of the coating composition wet mixture. Alternatively, the exemplary coating composition can comprise 15 wt. %-60 wt. % inorganic binder, preferably 20 wt. %-50 wt. % inorganic binder, more preferably 25 wt. %-45 wt. % inorganic binder, based on the total solids content in the dried coating.

Exemplary organic fibers comprise polyvinyl alcohol (PVA) fibers, polypropylene (PP) fibers, blended polyolefin fibers, polyolefin copolymer fibers, nylon fibers, or combinations thereof. The organic fiber can comprise 0.06% to 5% by weight of the wet coating composition mixture. Alternatively, the exemplary coating composition can comprise 0.1-6.5% by weight of organic fibers, preferably 0.3-3% by weight of organic fibers, more preferably 0.9-1.5% by weight of organic fibers based on the total solids content in the dried coating.

In some embodiments, the exemplary coating composition may comprise 35 wt. % to 85 wt. % inorganic filler, 15 wt. % to 60 wt. % inorganic binder and 0.1 wt. % to 6.5 wt. % organic fiber based on the total solids content in the dried coating. In other embodiments, the exemplary coating composition may comprise 50 wt. % to 80 wt. % inorganic filler, 20 wt. % to 50 wt. % inorganic binder and 0.3 wt. % to 3 wt. % organic fiber based on the total solids content in the dried coating. In yet other embodiments, the exemplary coating composition may comprise 55 wt. % to 75 wt. % inorganic filler, 25 wt. % to 45 wt. % inorganic binder and 0.9 wt. % to 1.5 wt. % organic fiber based on the total solids content in the dried coating.

As mentioned previously, the exemplary coating composition may be applied to the first major surface of a substrate to form exemplary fire barrier article that can be used as a protective device or system, such as a thermal/flame barrier. In an exemplary aspect, the fire resistant article will be capable of withstanding a high temperature (e.g. greater than 750° C., preferably greater than 1000° C., or more preferably greater than 1200° C.) particle ejection without perforation caused by a high energy thermal runaway event. Surprisingly, the chopped organic fibers may decrease or eliminate cracking of the exemplary cured inorganic coatings at high temperatures.

The exemplary coating composition may be applied by spraying, painting, screen printing, or the like. The exemplary coating composition can be a solvent based coating or an aqueous based coating, preferably an aqueous based coating composition.

In some embodiments, the exemplary coating composition may be coated and dried in a planar conformation without support materials to form an exemplary fire barrier article. This exemplary fire barrier article can be incorporated into or wrapped around a flammable energy storage device, such as lithium ion battery cells, modules, or packs, such as may be found in hybrid or electric vehicles or other electric transportation applications or locations. In other applications, the exemplary fire barrier article can be used as a lid/pack liner for said flammable energy storage devices. Exemplary energy storage devices can be used in battery storage applications, such as grid energy storage, home energy storage, industrial energy storage, and the like.

When the exemplary flame barrier material is used in an electric vehicle battery pack, its purpose is to prevent or slow a fire from entering the passenger compartment of the vehicle, to allow the vehicle occupants sufficient time to exit the vehicle. Similarly, when the exemplary flame barrier material is used in other battery storage applications, the purpose is to prevent or slow a fire resulting from a battery failure event from spreading to surrounding structures, thus, mitigating or slowing damage to the surrounding structures.

In some aspects, the exemplary coating may be coated on a substrate, such as an even layer on at least a portion of a two-dimensional substrate such as a flame resistant paper, such as an inorganic paper or mica based paper, an inorganic fabric, flame resistant boards, such as inorganic fiber boards or mica boards or sheets, or flame resistant laminate or multi-layered materials comprising one or more of the aforementioned materials to form an exemplary fire barrier article can be incorporated into or wrapped around a flammable energy storage device, such as lithium ion battery cells, modules, or packs, such as may be found in hybrid or electric vehicles or other electric transportation applications or locations. In an alternative aspect, the exemplary coating may be coated on a substrate, such as an even layer on at least a portion of a three-dimensional substrate as described previously to form a flame barrier article.

In some embodiments, the two-dimensional substrate can be thermally and electrically insulating and in the form of an inorganic insulating paper or board, such as is described in PCT Publication No. WO 2020/023357, incorporated herein in its entirety. Multiple sheets, i.e., plies or sub-layers of inorganic paper layer, may be wet laminated and pressed to yield an inorganic board or a multilayer paper material that is thermally and electrically insulating. The term “paper” refers to a flexible single or multilayer material that has sufficient flexibility to be bent around a 3-in. mandrel. The term “board” refers to a relatively stiff material that can be flexed, but which is not capable of wrapping around a mandrel.

Exemplary inorganic fabrics may comprise E-glass fibers, R-glass fibers, ECR-glass fibers, basalt fibers, ceramic fibers, silicate fibers, Nextel fibers, steel filaments or a combination thereof. The fibers in the inorganic fabric may be chemically treated. The fabrics may for example be a woven or nonwoven mat, a felt, a cloth, a knitted fabric, a stitch bonded fabric, a crocheted fabric, an interlaced fabric or a combination thereof.

Exemplary multilayer material can comprise at least one layer comprising inorganic particles or inorganic fibers or a combination thereof and a at least a second layer comprising a flame resistant foam nonwoven mat or other porous material; a flame-resistant fabric material or flame resistant polymeric materials in the form of films or nonwoven materials. The inorganic fibers of the at least one layer comprising inorganic particles or inorganic fibers may be selected from the group of E-glass fibers, S-glass fibers, R-glass fibers, ECR-glass fibers, basalt fibers, ceramic fibers, polycrystalline fibers, silicate fibers, alumina fibers, silica fibers, carbon fibers, silicon carbide fibers, boron silicate fibers or a combination thereof. More specific, the fibrous material may include annealed melt-formed ceramic fibers, sol-gel formed ceramic fibers, polycrystalline ceramic fibers, alumina-silica fibers, glass fibers, including annealed glass fibers or non-bio-persistent fibers. The inorganic fabric may for example be a non-woven mat, a stitch bonded mat, a needled mat, a chemically bonded mat using either an inorganic binder or a polymeric binder(both of which are described in more detail below) or thermally bonded mat (mono or bicomponent fibers or powders) or a combination thereof. Other fibers are possible as well, if they withstand the high temperatures generated in a thermal event of a Li-ion battery or other high energy battery.

In still other applications, the exemplary coating composition may be directly applied to a component of the battery module or pack, such as an aluminum lid for a battery pack.

The exemplary fire barrier article of the present invention should prevent heat from flowing from a failing cell or module to an adjacent cell or module or to the passenger compartment. For example, the exemplary fire barrier article should provide a high thermal gradient or temperature drop across the material when exposed to high temperature on one side of the material. In an alternative, the exemplary fire barrier article may be used as a thermal barrier wrap or as a thermal barrier lid in an electric vehicle battery pack that can prevent or reduce the rate of heat flow out of the battery pack.

Any of the exemplary fire barrier articles described above may further include an adhesive layer disposed on the substrate or the coated surface to attach the flame barrier article to a surface where protection is needed such as to the inner surface of a lid for a battery pack or module. The adhesive for the adhesive layer may be a pressure sensitive adhesive, a semi-structural B-staged hybrid adhesive, or thermosetting adhesive to bond the flame barrier article to a surface. The adhesive may be selected from the families of acrylic adhesives, epoxy adhesives, silicone adhesives, metal silicate adhesives, or similar adhesives.

In some aspects of the invention, a pressure sensitive adhesive can be bonded to the surface of the dried coating composition to adhere the dried coating composition to other substrates. In other embodiments, a curable adhesive such as sodium silicate, epoxy, silicone, or similar adhesives can utilized to bond this dried coating composition to other substrates.

The present invention may suitably comprise, consist of, or consist essentially of, any of the disclosed or recited elements. As used herein, the term “consisting essentially of” does not exclude the presence of additional materials which do not significantly affect the desired characteristics of a given composition or product.

For example, an exemplary coating composition in accordance with the present invention may consist essentially of an inorganic filler, an inorganic binder, and chopped organic fibers. This exemplary coating composition may further include additional materials such as defoamers, surfactants, rheological modifiers, forming aids, pH-adjusting materials, or combinations thereof, which do not significantly affect the desired characteristics of the cured coating composition or fire resistant article comprising the exemplary coating disposed on product a surface of a substrate. The inorganic filler, inorganic binder, and chopped organic fibers of this coating composition can be any of the materials provided for above in any of the combinations suggested.

Various modifications, equivalent processes, as well as numerous structures to which the present invention may be applicable will be readily apparent to those of skill in the art to which the present invention is directed upon review of the present specification.

### EXAMPLES

These examples are for illustrative purposes only and are not meant to be limiting on the scope of the appended claims. All parts, percentages, ratios, etc. in the examples and the rest of the specification are by weight, unless otherwise noted.

Test Methods

### Mechanical Properties

The flexural properties of the coated glass cloth samples were measured before and after aging at 85° C./85% relative humidity for 28 days using a slightly modified ASTM D790 3 point flexural test on an Insight 5 tensile tester. The aged samples were dried in an oven at 110° C. for 1 hour prior to testing. The span between supports was 25.4 mm and the crosshead speed was 5.1 mm/min. The measured flexural properties are shown in Table 3 as a percent change relative to a control material (CE 1) and in Table 5.

### Blast-Resistance Testing

The resistance of test specimens to a hot particle blast was tested to simulate an electric vehicle high energy battery in a thermal runaway condition. High energy batteries not only burn, but also blast particles that can erode through materials at their high burning temperatures.

After equilibrating the specimen with a 1200° C. flame, the specimen was subjected to a series of grit blasts lasting 10 seconds followed by a 5 second rest period. The grit was blasted at the substrate with a 25 psi compressed air pressure source; the grit particles were 120 grit aluminum oxide non-shaped media. These 10 second blasts with 5 second rest (with continuous application of the flame) were repeated until the flame and grit punctured through the test specimen. The coated side of the test specimen sheet construction was oriented towards the hot particle blast. The number of blasts survived before puncture through the entire construction was recorded and shown in Table 4.

Materials
KASIL® 1 Potassium silicate solution (MR>3.2; 29% Solids), available from PQ Corporation (Valley Forge, PA, USA).
KASIL® 6 Potassium Silicate Solution (2.6<MR≤3.2; 39.2% Solids), available from PQ Corporation (Valley Forge, PA, USA).
K® Sodium Silicate (KSS) Solution (2.6<MR≤3.2; 42.7% Solids), available from PQ Corporation (Valley Forge, PA, USA).
NALCO 2327 Colloidial Silica (40.0% solids), available from Nalco Chemical Company (Naperville, IL, USA)
Polyplate® P Water Washed Kaolin Clay, available from Kamin LLC (Macon, GA, USA).
Poly(vinyl alcohol) fibers, NYCON-PVA RMS702 chopped polyvinyl alcohol fiber, 24 micron diameter, 6 mm length, available from Nycon Corporation (Fairless Hills, PA, USA).
Polypropylene fibers, Nycon ProCon M chopped polypropylene fiber, 38 micron diameter, 19 mm length, available from Nycon Corporation (Fairless Hills, PA, USA).
Nylon Fibers, Nycon RC nylon fibers, 9 micron diameter, 3 mm length, available from Nycon Corporation (Fairless Hills, PA, USA).
Unifrax E-Glass Microfibers (6 micron diameter, 6 mm length), available from Unifrax (Tonawanda, NY, USA).
Suzorite 20S phlogopite mica (1300 micron median particle size), available from Imerys (Boucherville, Quebec, CA).
Suzorite 200 HK phlogopite mica powder (60 micron mean particle size), available from Imerys (Boucherville, Quebec, CA).
E-glass cloth—76 g/m² basis weight, 0.072 mm thick, available from JPS Composite Materials (Anderson, SC).

### Preparation of the Coating Compositions

All the solid components were added into the mixing vessel and were manually mixed. The inorganic binder was then added and manually mixed until the solids in the resultant slurry or paste were well-wetted. The mixture was then mixed in a FlackTek SpeedMixer for 2 minutes at 3,000 rpm. The composition of each coating composition is provided in Table 1.

TABLE 1
Exemplary coating composition in the wet coating composition

| | Binder | | Clay | | Fiber | | Mica | |
|---|---|---|---|---|---|---|---|---|
| | | Weight | | Weight | | Weight | | Weight |
| Example | Type | Fraction | Type | Fraction | Type | Fraction | Type | Fraction |
| CE 1 | Kasil 1 | 0.58 | Kaolin | 0.33 | | | 20S | 0.090 |
| CE 2 | Kasil 1 | 0.57 | Kaolin | 0.32 | | | 20S | 0.110 |
| CE 3 | Kasil 1 | 0.58 | Kaolin | 0.33 | Glass | 0.012 | 20S | 0.078 |
| CE 4 | Kasil 1 | 0.56 | Kaolin | 0.40 | Glass | 0.005 | 20S | 0.035 |
| CE 5 | Kasil 1 | 0.56 | Kaolin | 0.40 | Glass | 0.0025 | 20S | 0.0375 |
| CE 6 | Kasil 6 | 0.64 | Kaolin | 0.36 | | | | |
| Ex. 1 | Kasil 1 | 0.58 | Kaolin | 0.33 | PVA | 0.003 | 20S | 0.087 |
| Ex. 2 | Kasil 1 | 0.58 | Kaolin | 0.33 | PVA | 0.006 | 20S | 0.084 |
| Ex. 3 | Kasil 1 | 0.58 | Kaolin | 0.33 | PVA | 0.012 | 20S | 0.078 |
| Ex. 4 | Kasil 1 | 0.56 | Kaolin | 0.33 | PVA | 0.006 | 20S | 0.084 |
| Ex. 5 | Kasil 6 | 0.66 | Kaolin | 0.34 | PP | 0.0006 | | |
| Ex. 6 | KSS | 0.61 | Meta- | 0.35 | Nylon | 0.04 | | |
| | | | Kaolin | | | | | |
| Ex. 7 | KSS | 0.78 | Meta- | 0.11 | Nylon | 0.01 | 200HK | 0.10 |
| | | | Kaolin | | | | | |
| Ex. 8 | Nalco 2327 | 0.409 | Kaolin | 0.41 | PP | 0.001 | 200HK | 0.18 |
| Ex. 9 | Nalco 2327 | 0.339 | Kaolin | 0.41 | PP | 0.001 | 200HK | 0.25 |
| Ex. 10 | Kasil 6 | 0.64 | Kaolin | 0.357 | PVA | 0.003 | | |
| Ex. 11 | Kasil 6 | 0.64 | Kaolin | 0.35 | PVA | 0.01 | | |

Note:
Because of the differing densities of PVA fiber and glass fiber, the fiber volume fraction of Ex. 3 (0.6 wt. % PVA fiber) is approximately the same as the fiber volume fraction of Ex. 6 (1.2 wt. % glass fiber).

The coating compositions of Examples Ex. 1 through Ex. 4 and Comparative Examples CE 1 through CE 5 were coated onto a thin e-glass cloth and dried at 100° C. for 68 hours. Coating weights of the dried compositions were approximately 1400 g/m².

The coating compositions of Examples Ex. 5, Ex. 6, Ex. 7, Ex. 9, Ex. 10, and Ex. 11 were coated onto a release liner and dried at 120° C. for 16 hours. The coating weight for Ex. 5 and Ex. 6 were approximately 1700 g/m². The coating weight for Ex 7 was approximately 1300 g/m². The coating weight for Ex 9 was approximately 2600 g/m². The coating weight for Ex 10 was approximately 1400 g/m², and the coating weight for Ex 11 was approximately 1300 g/m².

The coating composition of Example Ex. 8 was coated onto a flame resistant paper such as the flame resistant papers described in PCT Publication No. WO 2020/023357. The coating weight of Ex. 8 (excluding the flame resistant paper) was 2000 g/m².

TABLE 2
Exemplary coating composition in the dried
coating provided in weight percent

| Example | Binder | Filler | Fiber |
|---|---|---|---|
| CE 1 | 28.7 | 71.3 | |
| CE 2 | 27.8 | 72.2 | |
| CE 3 | 28.7 | 69.3 | 2.0 |
| CE 4 | 27.0 | 72.1 | 0.8 |
| CE 5 | 27.0 | 72.6 | 0.4 |
| CE 6 | 41.1 | 58.8 | |
| Ex. 1 | 28.7 | 70.8 | 0.5 |
| Ex. 2 | 28.7 | 70.3 | 1.0 |
| Ex. 3 | 28.7 | 69.3 | 2.0 |
| Ex. 4 | 28.7 | 70.3 | 1.0 |
| Ex. 5 | 43.1 | 56.8 | 0.1 |
| Ex. 6 | 40.0 | 53.8 | 6.1 |
| Ex. 7 | 60.2 | 38.0 | 1.8 |
| Ex. 8 | 21.7 | 78.2 | 0.1 |
| Ex. 9 | 17.0 | 82.9 | 0.1 |
| Ex. 10 | 41.1 | 58.4 | 0.5 |
| Ex. 11 | 41.1 | 57.3 | 1.6 |

TABLE 3
Flexural properties of exemplary coating compositions compared
to comparative example CE 1 containing no fiber filler

| | | Fiber | Modulus, | | Stress at Break, | | Strain at Break, | |
|---|---|---|---|---|---|---|---|---|
| Exam- | Fiber | Wt. | relative to CE 1 | | relative to CE 1 | | relative to CE 1 | |
| ple | Type | % | Initial | Aged | Initial | Aged | Initial | Aged |
| Ex. 1 | PVA | 0.3 | 49% | 33% | 34% | 16% | −11% | −13% |
| Ex. 2 | PVA | 0.6 | 29% | 26% | 24% | 26% | −9% | 1% |
| Ex. 3 | PVA | 1.2 | 65% | 38% | 39% | 19% | −16% | −14% |
| CE 3 | Glass | 1.2 | 17% | −3% | 10% | −1% | −10% | 0% |

Note:
the fiber weight percent is given as the amount of fiber in the wet coating composition.

From Table 3, it can be seen that the addition of PVA fiber to the coating composition improves the flexural modulus and flexural stress at break of the coating composition relative to the control sample CE 1 and is also higher than that of the coating composition that includes glass fiber (Ex. 5). In addition, the humidity-aged data shows that the flexural modulus and flexural stress at break of the glass fiber composition is about the same as the control while these properties for the PVA fiber continue to be greater than those of the control (or glass fiber). The addition of either type of fiber does not increase flexural strain at break.

TABLE 4
Blast-Resistance Testing of exemplary coating compositions

| | Coating | | |
|---|---|---|---|
| | Weight | Blasts | |
| Example | (g/m²) | Survived | Observations |
| CE 2 | 1301 | 11 | |
| Ex. 4 | 1392 | 12 | |
| CE 4 | 1308 | 8 | |
| CE 5 | 1185 | 7 | |
| CE 6 | 1516 | 16 | cracked when exposed to heat |
| Ex. 10 | 1432 | 9 | cracked when exposed to heat |
| Ex. 11 | 1309 | 11 | No cracking when exposed to heat |

Comparison of Example Ex. 4 with comparative examples CE 2, CE 4, and CE 5 in Table 4 shows that the addition of the organic fibers does not adversely affect the number of blasts survived. Thus, it has been found that addition of organic fibers to the exemplary inorganic coatings enhances the flexural properties of the coating while maintaining good blast and heat resistance.

TABLE 5
Flexural properties of exemplary coating compositions
and their values relative to comparative example CE 6

| | | | | | | | Stress at | Strain at |
|---|---|---|---|---|---|---|---|---|
| | | | | Stress at | Strain at | Modulus, | Break, | Break, |
| | Fiber | Fiber | Modulus | Break | Break | relative to | relative to | relative to |
| Example | Type | Wt. % | (MPa) | (MPa) | (%) | CE 6 | CE 6 | CE 6 |
| Ex. 10 | PVA | 0.3 | 11,700 | 22.8 | 0.20 | 0% | 17% | 18% |
| Ex. 11 | PVA | 1.0 | 15,300 | 27.1 | 0.18 | 31% | 39% | 6% |
| CE 6 | None | | 11,700 | 19.5 | 0.17 | | | |

Note:
the fiber weight percent is given as the amount of fiber in the wet coating composition.

While comparative example CE 6 had a tendency to crack when exposed to heat, Example Ex. 10, which had a composition that was substantially the same as that of CE6, except that Ex. 10 includes 0.5 wt. % organic fibers in the dried coating, had an increased flexural modulus. However, the sample of Ex. 10 still cracked when exposed to high temperature (˜1200° C.). Increasing the organic fibers to 1.6 wt. % in the dried coating, as provided by Ex. 11, showed that the addition of organic fibers at an appropriate level can prevent cracking when exposed to high temperature while also providing good blast resistance.

Thus, the organic fibers increase both the flexural modulus and strength of these inorganic coatings. Surprisingly, incorporating organic fibers in these inorganic systems has demonstrated unexpected high temperature, blast resistant properties at temperatures well beyond the thermal stability of the organic fibers. In addition, the organic fibers can also decrease the tendency of some inorganic coatings to crack at high temperatures despite the organic fibers being well beyond their thermal stability limit.

1. A coating composition comprising:
an inorganic filler;
an inorganic binder; and
chopped organic fibers,
wherein the inorganic filler comprises 35 to 85% by weight of the coating composition, wherein the inorganic binder comprises 15 to 60% by weight of the coating composition, and wherein the organic fiber comprises 0.1% to 6.5% by weight of the coating composition.

2. The coating composition of claim 1, wherein the inorganic filler is one of kaolin clay, metakaolin, talc, mica, mullite, phlogopite, muscovite, montmorillonite, smectite, bentonite, illite, chlorite, sepiolite, attapulgite, halloysite, vermiculite, laponite, rectorite, perlite, fly ash, fumed silica, silica fume, Portland cement, and concrete mixes.

3. The coating composition of claim 1, wherein the inorganic filler is a mixture of inorganic fillers comprising at least two fillers selected from kaolin clay, metakaolin, talc, mica, mullite, phlogopite, muscovite, montmorillonite, smectite, bentonite, illite, chlorite, sepiolite, attapulgite, halloysite, vermiculite, laponite, rectorite, perlite, fly ash, fumed silica, silica fume, Portland cement, and concrete mixes.

4. The coating composition of claim 1, wherein the inorganic filler comprises a mixture of kaolin clay and mica.

5. The coating composition of claim wherein the inorganic binder comprises an alkali silicate selected from the group consisting of sodium silicate, potassium silicate, and lithium silicate.

6. The coating composition of claim 1, wherein the inorganic binder further comprises a colloidal silica.

7. The coating of claim 1, wherein the inorganic binder comprises a polysilicate having the formula M₂O(SiO₂)ₙ·H₂O, wherein M is selected from Li, Na, or K and n is an integer between 1 and 15, preferably between 2 and 9.

8. The coating composition of claim 1, wherein the organic fibers comprise polyvinyl alcohol fibers, polypropylene fibers, blended polyolefin fibers, polyolefin copolymer fibers and nylon fibers.

9. The coating composition of claim 1, wherein the organic fibers consist of polyvinyl alcohol fibers.

10-12. (canceled)

13. A fire resistant article wherein the coating composition of claim 1 has been applied to a planar surface of a substrate.

14. The fire resistant article of claim 13, wherein the fire resistant article is capable of withstanding a high temperature (1200° C.) particle ejection without perforation caused by a high energy thermal runaway event.

15. The fire resistant article of claim 13, wherein the substrate comprises one of a glass cloth, a basalt cloth, a mica board, a flame resistant inorganic paper or board and another high temperature-resistant material.

16. A fire resistant article of claim 13, wherein the coating composition of claim 1 has been applied to a three-dimensional surface of a substrate.

17. The fire resistant article of claim 16, wherein the three-dimensional surface is an inner surface of an aluminum lid for a battery pack.

18. (canceled)

19. The fire resistant article of claim 13, further comprising a pressure sensitive adhesive disposed on a cured coated surface disposed on the substrate.

20. The coating composition of claim 1, wherein the chopped organic fibers improve the modulus of a cured coating layer formed from the coating composition by at least 24%.

21. The coating composition of claim 1, wherein the chopped organic fibers improve the stress at break of a cured coating layer formed from the coating composition by at least 24%.

22. The coating composition of claim 1, wherein the coating composition consists essentially of the inorganic filler, inorganic binder and organic fibers.

23. The coating composition of claim 1, wherein the chopped organic fibers in the coating composition decreases cracking of the cured coating when heated to high temperatures.

24. A coating composition comprising:
an inorganic filler;
an inorganic binder; and
chopped organic fibers, wherein the inorganic filler comprises 35 to 85% by weight of the coating composition, wherein the inorganic binder comprises 15 to 60% by weight of the coating composition, and wherein the organic fiber comprises nylon fibers of 0.1% to 6.5% by weight of the coating composition.
